(19) United States
(12) Patent Application Publication
(10) Pub. No.: US 2006/0221838 A1
(43) Pub. Date: Oct. 5, 2006

(54) SIP maintenance unit

(75) Inventors: Robert Raymond Hartoin, Tinton Falls, NJ (US); T. Scott Kennedy, Eatontown, NJ (US); Jeffrey Skelton, Perrineville, NJ (US)

Correspondence Address: DAVIDSON BERQUIST JACKSON & GOWDEY LLP, 4300 WILSON BLVD., 7TH FLOOR, ARLINGTON, VA, 22203, US

(73) Assignee: Net2Phone, Inc., Newark, NJ (US)

(21) Appl. No.: 11/092,909

(22) Filed: Mar. 30, 2005

(51) Int. Cl. H04L 1/00

(52) U.S. Cl. 370/242

(57) ABSTRACT

A method and system are provided for managing voice and multimedia sessions over a network. The method includes initializing a SIP maintenance unit, performing tests on SIP proxies, adjusting a value of a counter based on the results of the tests, and managing the voice and multimedia sessions based on the results of the tests. The system includes SIP proxies, a SIP session initiator for selecting a SIP proxy to establish a media path, error counters, and a SIP maintenance unit for communicating between the components of the system and testing the SIP proxies. The system and method improve the performance of call routing and the average quality of media paths established for communicating multimedia data by testing the SIP proxies of a communication environment have varying characteristics.

### BACKGROUND OF THE INVENTION

1. Field of the Invention

This invention relates generally to a method and system for managing voice and multimedia sessions over a network. More specifically, this invention relates to a method and system for managing voice and multimedia sessions using Session Initiation Protocol (SIP) and performing tests on the SIP proxies of a system to select an appropriate SIP proxy based on the results of the tests.

2. Discussion of the Background

Session initiation protocol (SIP) is the Internet Engineering Task Force's (IETF's) standard for multimedia conferencing over a network that can be used to establish, maintain, and terminate calls between two or more endpoints. Like other Voice over Internet Protocol (VoIP), such as H.323, SIP is designed to address the functions of signaling and session management within a packet telephony network. SIP is a flexible protocol designed to be a genera purpose way to set up real time multimedia sessions between groups of users. For example, SIP can be used for telephone calls, video and audio multicast meetings, and instant messaging conferences.

SIP is a peer-to-peer protocol, wherein the end users are referred to as user agents. Although user agents using two SIP devices can communicate directly with each other, communication is normally completed using an intermediary system that acts as a SIP proxy. A SIP proxy is an intermediary device that receives SIP requests from a user agent and then forwards the request. SIP proxies provide functions such as authentication, authorization, network access control, routing, reliable request retransmission, and security. The SIP proxies only participate in the SIP messages, meaning that once a communication link is established the communicated multimedia data will generally go directly from one user agent to another user agent.

Managing SIP services on behalf of multiple carriers and enterprises entails establishing media paths by signaling remote SIP proxies. However, a SIP-services management company has little or no control over the remote SIP proxies. Therefore, the company has no control over the server characteristics, i.e., platform brands, features, software versions, Operations and Maintenance (O&M) applications, etc. of the remote SIP proxies. The SIP proxies are likely to meet the SIP standards defined in IETF RFC 3261, which are herein incorporated by reference. However, the standards do not specify the characteristics mentioned above. Therefore, SIP-services management applications such as Simple Network Management Protocot the vendors of the applications, the features, and the version numbers are likely heterogeneous across the customer base of a SIP-services management company.

SIP-services management companies sell the service of monitoring and managing a carrier's or enterprise's SIP communication environment. Therefore, in order to be competitive with other SIP-services management companies, a management company does not want to force a prospective customer (carriers and enterprises) into standardizing their SIP infrastructures to improve manageability since such a standardization would entail significant capital investment, and therefore would likely not be welcomed by prospective customers. The attempt to standardize SIP proxy O&M software within and across carriers and enterprises results in a significant marketing problem. Prospective customers view the standardization of their communication environment as expensive and as presenting a barrier to swapping SIP-services management companies in the future.

FIG. 1 illustrates a SIP communication environment managed by an SIP-services management company. In FIG. 1, the SIP communication environment includes back-to-back user agents (B2BUAs) 1, a Network Operation Center (NOC) 2, an SIP proxy 1 using Carrier A, an SIP proxy 2 using Carrier B, a call origination terminal 3, and a call termination terminal 4. The dashed lines 5 represent signaling information exchanged between components of the communication system, and the solid line 6 represents a media path for conducting a multimedia session between the call origination terminal 3 and call termination terminal 4. In the SIP communication environment of FIG. 1, the components and their interactions follow the SIP standards as defined in IETF RFC 3261. The dashed lines 5 representing signaling information used in establishing the media path 6. The media path 6 between the call origination terminal 3 and the call termination terminal 4 is established via Carrier A, Carrier C, and Carrier B. In the communication environment of FIG. 1, the SIP-services management company is concerned with the overall reliability of the communication system, which as discussed above, is effected by the non-uniformity of the components of the communication system.

FIG. 2 illustrates a communications environment in which a carrier manages their own SIP services instead of using an SIP-services management company. The communication environment of FIG. 2 has greater control over the B2BUAs 1, the NOC 2, the call origination terminal 3, and the originating carrier, and thus can establish a high uniformity between the components leading to an increase in the reliability of communications within the originating carrier's control However, carriers managing their own SIP services must still be cognizant of components outside of the originating carrier, i.e., SIP proxy 1, SIP proxy 2, and the call termination terminal 4. Therefore, carriers managing their own SIP services are still effected by non-uniformities within the communication environment of FIG. 2 since a call termination terminal 4 is still involved with the signaling information 5 and media path 6.

The current methods of managing voice and multimedia sessions using the SIP standard do not address reliability issues stemming from non-uniformities within the components of the communication environment, i.e., O&M applications, their vendors, features, and version numbers that are likely heterogeneous across the communication environment. Therefore, current methods of managing voice and multimedia session are unable to recognize compatibility issues that arise due to the non-uniformities of the components of a system resulting in connection, routing, and reliability problems.

### SUMMARY OF THE INVENTION

The present invention obtains as much SIP-proxy status information as possible by performing tests on the SIP proxies of a communication environment using standard SIP messages. The present invention also enables the routing of session related signaling around malfunctioning or overloaded remote SIP proxies. Further, the present invention enables reestablishing session related signaling through previously malfunctioning SIP proxies when the malfunctioning SIP proxies begin responding normally.

These and other objects and purposes of the invention may be achieved using a method for managing voice and multimedia sessions over a network that includes initializing a SIP maintenance unit, performing tests on SIP proxies, adjusting a value of a counter based on the results of the tests, and managing the voice and multimedia sessions based on the results of the tests. The method may be implemented using a system for managing voice and multimedia session over a network that includes SIP proxies, a SIP session initiator for selecting an appropriate SIP proxy to establish a media path from a list of available proxies, error counters, and a SIP maintenance unit for communicating between the components of the system and testing the SIP proxies.

It is to be understood that both the foregoing general description of the invention and the following detailed description are exemplary, but are not restrictive, of the invention.

### BRIEF DESCRIPTION OF THE DRAWINGS

A more complete appreciation of the invention and many of the attendant advantages thereof will be readily obtained as the same becomes better understood by reference to the following detailed description when considered in connection with the accompanying drawings, wherein:

FIG. 1 illustrates a conventional SIP communication environment managed by an SIP-services management company;

FIG. 2 illustrates another conventional SIP communication environment that is managed by an originating carrier or enterprise;

FIG. 3 illustrates an SIP communication environment including an exemplary embodiment of a system for managing voice and multimedia sessions over a network;

FIG. 4 illustrates a block diagram of a SIP maintenance unit included in an exemplary embodiment of a system for managing voice and multimedia session over a network;

FIG. 5 illustrates a flowchart of a test performed on SIP proxies according to an exemplary embodiment of the present invention;

FIG. 6 illustrates a flowchart of a “Take Action” step of a test performed on the SIP proxies according to an exemplary embodiment of the present invention;

FIG. 7 illustrates a flowchart of an SIP-proxy status test according to an exemplary embodiment of the present invention;

FIG. 8 illustrates a flowchart of a “Ping Test” of an exemplary embodiment of the present invention; and

FIG. 9 illustrates a computer that may be used to implement the method and system of the present invention.

### DETAILED DESCRIPTION OF THE PREFERRED EMBODIMENTS

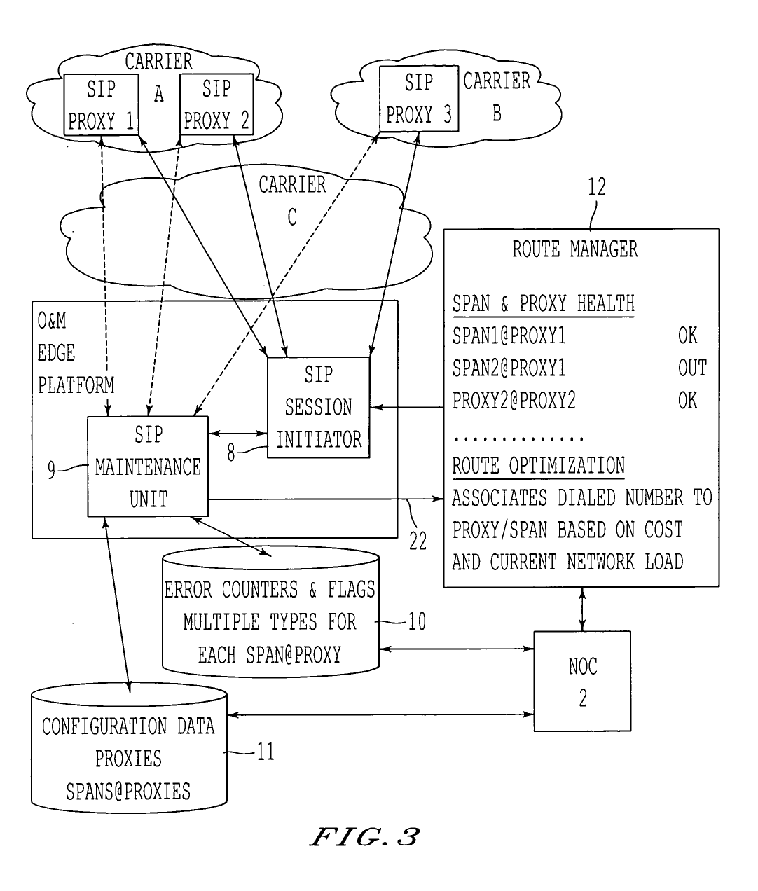

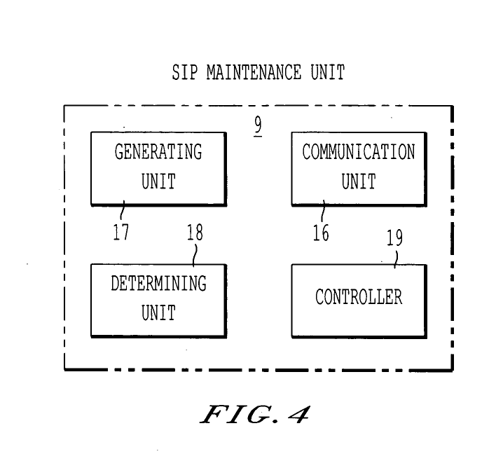

Referring now to the drawings, wherein like reference numerals designate identical or corresponding parts throughout the several views, FIG. 3 illustrates a non-limiting example of the present invention. FIG. 3 illustrates a system for managing voice and multimedia sessions over a single or multiple networks such as the Internet Carrier A, Carrier B, and Carrier C. The system includes at least one SIP proxy SIP proxy 1, SIP proxy 2, and SIP proxy 3, each of which are configured to control media paths used for transferring data between two users. Call origination is initiated by a first user and call termination is completed by the end user. Call origination and call termination typically involve one or more of the following: an SIP phone call; a Public Switch Telephore Network (PSTN) phone call through a media gateway; a plain telephone-behind-MTA (Media Terminal Adapter) call; and a multimedia-device call (e.g., video conferences). The devices used by the first user and end user for call origination and termination may access carrier networks through wired or wireless means. The system also includes at least one SIP session initiator 8 and at least one SIP maintenance unit 9 to test and establish communication with the SIP proxies SIP proxy 1, SIP proxy 2 and SIP proxy 3. Signaling information is exchanged between the SIP session initiator 8, the SIP maintenance unit 9, and the SIP proxies SIP proxy 1, SIP proxy 2, and SIP proxy 3 to test and establish communications within the system

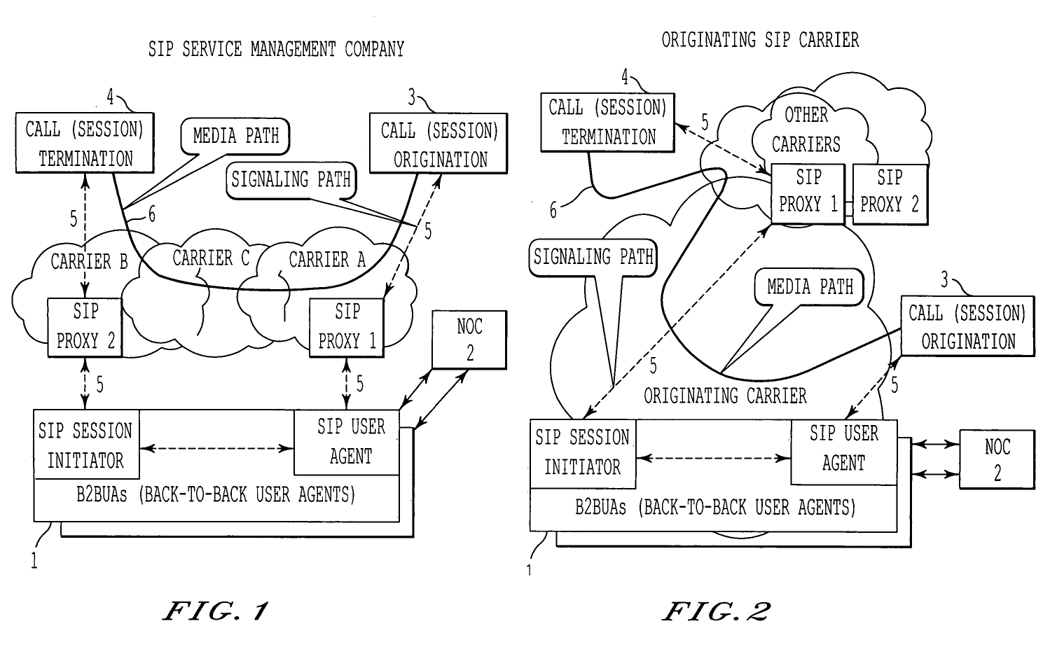

The SIP session initiator 8 is used to establish a media path between two SIP proxies. The SIP session initiator 8 is configured to receive a call-initiation request from a user via a SIP proxy and select an appropriate SIP proxy to use to establish a media path with the desired end user, thereby enabling data communication between the two users. Each SIP proxy includes a plurality of spans controlled by the SIP proxy through which the actual data is transmitted during a multimedia session Each span represents a connection for establishing a media path that is under the control of a specific SIP proxy. The spans are used for the media communications, whereas the SIP proxies only communicate via signaling messages as shown by the dashed lines in FIGS. 1 and 2 and solid lines in FIG. 3. The SIP session initiator 8 is configured to select an appropriate SIP proxy from the list of available proxies provided by the SIP maintenance unit 9 based on cost and the availability of spans in each of the SIP proxies.

In FIG. 3, the SIP maintenance unit 9 is configured to collect signaling information from the SIP session initiator 8, perform tests on the SIP proxies, and manage the voice and multimedia sessions based on the tests of the SIP proxies. The SIP maintenance unit 9 exchanges signaling information (dashed arrows) with the SIP proxies, SIP proxy 1, SIP proxy 2, and SIP proxy 3 over the same physical network connection (solid arrows) used by the SIP session initiator 8 to communicate with the SIP proxies, SIP proxy 1, SIP proxy 2 and SIP proxy 3. Carrier C is illustrated to demonstrate that the carriers used by the SIP proxies need not be directly connected to the network for which the SIP services are managed. The tests performed by the SIP maintenance unit 9 and actions taken by the SIP maintenance unit 9 increase the reliability of call completion by enabling the SIP session initiator 8 to select an appropriate SIP proxy for communicating with an end user from a list of available proxies generated and modified by the SIP maintenance unit 9. The SIP maintenance unit 9 illustrated in the communication environment of FIG. 3 can also be incorporated into in the communication environments of FIGS. 1 and 2, thereby improving the average quality of service for multimedia sessions established in the communication environments of FIGS. 1 and 2.

The SIP maintenance unit 9 is initialized based on the configuration data 11 (e.g., in the format of a file or database entries), thereby configuring the SIP maintenance unit 9 to operate within a communication environment such as the communication environment illustrated in FIG. 3. The configuration data 11 is used to provide system information including, but not limited to, SIP proxy information error counter information, flags and alarm information, and testing procedures performed by the SIP maintenance unit 9.

As illustrated in the exemplary embodiment of the system of the present invention in FIG. 3, the configuration data may be provided by the NOC 2. The NOC 2 may be used generate, edit, and provide the configuration data 11 to the SIP maintenance unit 9. The configuration data 11 may be input manually by NOC personnel. The configuration data 11 is used to initialize the SIP maintenance unit 9, generate an initial list of available proxies and their corresponding spans, tailor specific tests performed by the SIP maintenance unit 9 for each SIP proxy SIP proxy 1, SIP proxy 2, and SIP proxy 3 depending on the SIP proxy's characteristics, and configure the settings of the error counters and flags 10 adjusted by the SIP maintenance unit 9 during tests. Configuring the settings of the error counters and flags 10 includes assigning thresholds to the counters which may be used in comparisons made by the SIP maintenance unit 9.

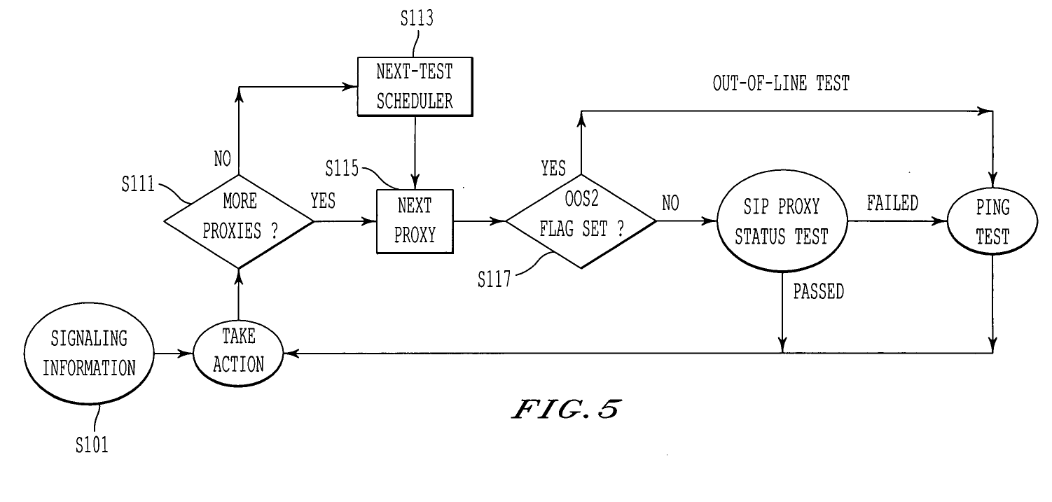

FIG. 4 is a block diagram of a non-limiting example of the SIP maintenance unit 9 included in the system of the present invention that is configured to perform tests on the SIP proxies SIP proxy 1, SIP proxy 2, and SIP proxy 3. The SIP maintenance unit 9 includes a generating unit 17, a communication unit 16, a determining unit 18, and a controller 19.

The controller 19 of the SIP maintenance unit 9 is configured to identify attributes of the SIP proxies of the system, generate a list of available SIP proxies, obtain error counter information, and control the tests performed by the SIP maintenance unit 9 based on the configuration data 11. The attributes identified for each SIP proxy, SIP proxy 1, SIP proxy 2, and SIP proxy 3 include, but are not limited to, the nature of the SIP proxies, information on the spans controlled by each SIP proxy, the number of spans controlled by each SIP proxy and the status of the spans. The identified SIP proxy attributes are then used to generate an initial list of available proxies. A non-limiting example of a partial list of available proxies is illustrated under the “Span & Proxy Status” heading in the route manager 12 of FIG. 3.

The route manager 12 may be used to store a list of available proxies and their corresponding spans. The partial list of route manager 12 illustrates that Span1@proxy1 is. OK, Span2@Proxy1 is OUT, and Proxy2@Proxy2 is OK. Therefore, according to this partial list, the SIP maintenance unit 9 may instruct the SIP session initiator 8 to use either Span1@proxy1 of SIP Proxy 1 or a span on SIP Proxy 2, which are all available as indicated by the OK located beside Proxy2@Proxy2. Further, the route manager 12 includes a route optimization algorithm that may be modified by the SIP maintenance unit 9 to further instruct how the SIP session initiator 8 selects an appropriate SIP proxy for a media path from the list of available proxies. The Route Optimization algorithm in FIG. 3 is based on cost and current network load.

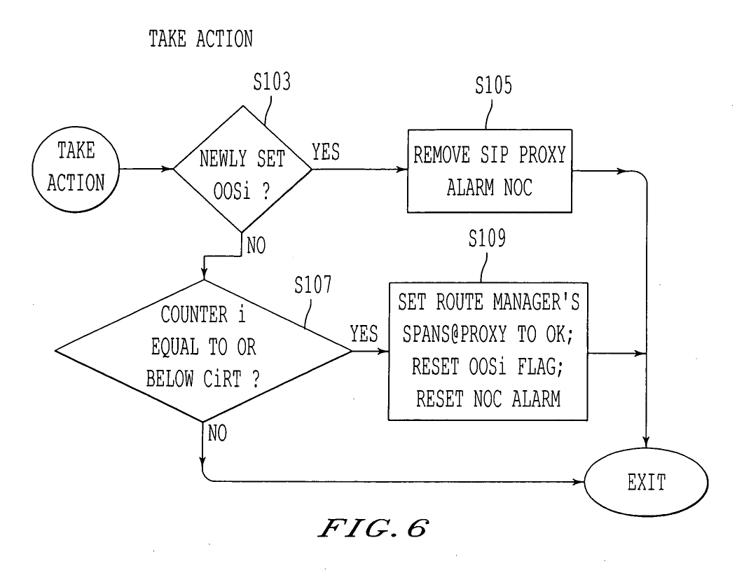

As shown by line 22 in FIG. 3, the list of available proxies and route optimization algorithm may be modified by the SIP maintenance unit 9 based on the results of tests performed by the SIP maintenance unit 9 discussed later in the specification with respect to FIGS. 5-8. The SIP maintenance unit 9 is configured to conduct tests on all of the SIP proxies of the system including SIP proxies that have failed previous tests and as a result are not included in the list of available proxies. Testing all of the SIP proxies enables the SIP maintenance unit 9 to automatically recover previously malfunctioning SIP Proxies by adding the SIP proxies to the list of available SIP proxies when the SIP proxies begin responding normally to the tests illustrated in FIGS. 5-8.

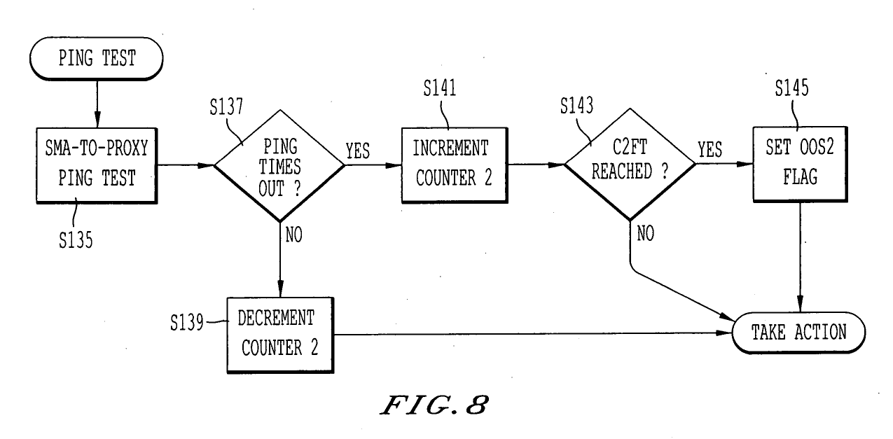

The controller 19 of the SIP maintenance unit 9 is further configured to obtain information for the error counters used in the system. In an exemplary embodiment of the present invention, there is an error counter for each span of the plurality of spans included in each SIP proxy. Further, there is an error counter for each type of error recorded for both signaling information received from the SIP session initiator 8 and errors related to the tests performed by the SIP maintenance unit 9. For example, error counters may be provided for recording signaling information including, but not limited to, hardware outages, ring no answers, busy signals, and network malfunctions. Likewise, counters related to the tests completed by the SIP maintenance unit 9 include, but are not limited to, error counters for recording each SIP proxy's “SIP-proxy status test” failures and “Ping Test” failures described later with respect to FIGS. 7 and 8, respectively.

The type of error counters used in the present invention may vary. For example, time-smoothed error counters may be used to limit the effects of quick variations in the results of tests that may result in false alarms. In an exemplary embodiment of the present invention, time-smoothed error counters are implemented in conjunction with the use of hysteresis bands used to promote stable system behavior. Hysteresis bands represent a difference between the failure threshold used to activate an alarm or set a flag and the recovery threshold used to deactivate an alarm or reset a flag. Using the time-smoothed error counters in combination with the hysteresis bands prevents the taking of proxies and spans in and out of service when there is only a small fluctuation of an error counter around a threshold value. Further, the error counters used in the present invention are incremented and decremented by the SIP maintenance unit 9 based on test results and/or signaling information provided by the SIP session initiator. The SIP maintenance unit 9 may be configured to increment and decrement the error counters using the same or different increment value. Further, the SIP maintenance unit may be configured to increment or decrement the value of a counter a specified time intervals.

The controller 19 is further configured to instruct the generating unit 17 to begin the tests conducted by the SIP maintenance unit 9. The generating unit 17 of the SIP maintenance unit 9 is configured to generate a test signal that will be transmitted to an SIP proxy via the communication unit 16. The test signal includes unique identification information for identifying the SIP proxy and corresponding span being tested and a test message that prompts a response from the SIP proxy. For example, the test signal may include an OPTION; BYE, or INVITE test message along with the unique identification information for the SIP proxy being tested. The test messages as well as the interactions between all components of the system of the present invention follow the SIP standards as defined in IETC RFC 3261. The communication circuit 16 of the SIP maintenance unit 9 is configured to transmit the test signal provided by the generating circuit 17 to a SIP proxy and receive a response from the SIP proxy. The determining unit 18 is configured to analyze a response received from the SIP proxy and determine if the test is passed or failed.

FIGS. 5-8 are used to explain a non-limiting example of repetitive tests performed by the SIP maintenance unit 9 on the SIP proxies SIP proxy 1, SIP proxy 2, and SIP proxy 3 included in the system of the present invention. The SIP maintenance unit 9 may be configured to conduct the tests on the SIP proxies SIP proxy 1, SIP proxy 2, and SIP proxy 3 in a variety of formats, i.e. specified time intervals, prescheduled times, arbitrary selection and round-robin. In the exemplary embodiment of the tests illustrated in FIGS. 5-8, the SIP proxies SIP proxy 1, SIP proxy 2, and SIP proxy 3 are tested using a round-robin format of test which is initiated at prescheduled times and when new SIP proxies are added to the system of the present invention. Other possible testing times include when one or more errors are reported or a connection is behaving outside of normal parameters (e.g., voice quality is poor or establishment of a connection is slow).

FIG. 5 is an exemplary embodiment of tests conducted by the SIP maintenance unit 9. In FIG. 5, step S101 represents signaling information that may be provided before tests are conducted by the SIP maintenance unit 9. As previously stated, the SIP maintenance unit 9 is initialized based on configuration data 11 and receives signaling information from SIP session initiator 8. The signals exchanged between the SIP session initiator 8 and the SIP proxies, SIP proxy 1, SIP proxy 2, and SIP proxy 3 may identify certain failures within the system using in-line tests conducted on spans before or during a media session. The SIP session initiator may provide the signaling information to the SIP maintenance unit 9 during or prior to the tests performed by the SIP maintenance unit 9.

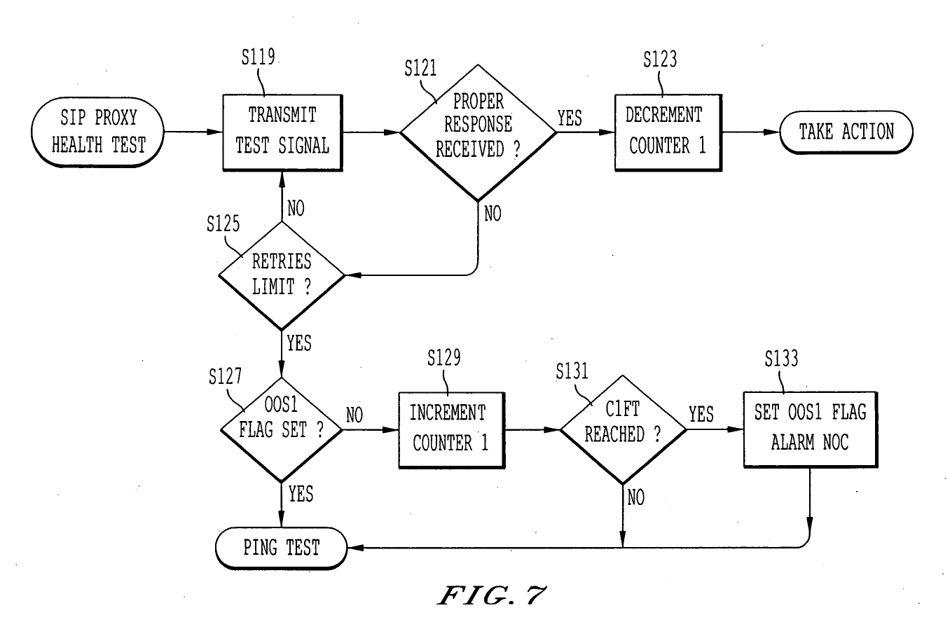

The “Take Action” step is used by the SIP maintenance unit 9 to manage voice and multimedia sessions over a network based on previous tests performed by the SIP maintenance unit 9 and/or signaling information received from the SIP session initiator 8. A non-limiting example of a Take Action step is illustrated in FIG. 6. In the Take Action step, the SIP maintenance unit 9 add/removes SIP proxies and spans from the list of available proxies, sets/resets flags, and activates/deactivates alarms (e.g., step S105 and step S109 of FIG. 6). SIP proxies and spans are added and removed from the list of available proxies to prevent the SIP session initiator 8 from selecting a SIP proxy that is unavailable.

Flags are set and reset during the testing procedures in order to direct the next test on the same SIP proxy to proceed without conducting unnecessary steps on the same SIP proxy (e.g., step S117 of FIG. 5). The SIP maintenance unit 9 is configured to set and reset different types of flags for each different type of error monitored by the SIP maintenance unit 9. The flags set and reset during the tests performed by the SIP maintenance unit 9 include, but are not limited to, an OOS1 flag indicating the tested SIP proxy caused an out-of-service condition by failing to properly respond to the test signal and an OOS2 flag indicating the network caused an out-of-service condition evidenced by a Ping Test failure.

Whereas flags are used to direct the testing procedure, alarms are used for notification. For example, an alarm may indicate that a SIP proxy has been taken off the list or that a SIP proxy is not operating efficiently but has not been taken off the list because the SIP proxy is still functional. Further, the activation of an alarm may trigger the transmission of an alarm email message to users who register to receive alarms. Users can register to receive email alarm notifications by placing their email address and the alarms they wish to receive in the configuration data 11 that is used to initialize the SIP maintenance unit 9.

FIG. 6 is a detailed flowchart of the Take Action procedure represented as the Take Action step in FIGS. 5, 7, and 8. In FIG. 6, OOSi represents a specific threshold flag that corresponds to a specific error, and CiRT represents a recovery threshold for a counter used for monitoring the specific error. In step S103, the controller 19 is configured to determine if the OOSi flag is newly set. If controller 19 determines that an OOSi flag is newly set, then the Take Action procedure proceeds to step S105, wherein the SIP maintenance unit 9 modifies the list of available proxies to remove the SIP proxy that triggered the setting of the OOSi flag. Further, if an OOSi flag is newly set, then an NOC alarm may be set triggering appropriate alarm notifications. After the list of available proxies is modified, the Take Action procedure is exited.

Conversely, if the controller 19 determines that an OOSi flag is not newly set in step S103, then the Take Action procedure proceeds to step S107, wherein the controller 19 determines if a SIP proxy or span of a SIP proxy should be added to the list of available proxies, an OOSi flag should be reset, or a NOC alarm should be reset. In step S107, the controller 19 is configured to compare the value of a counter with a threshold value CiRT assigned to the counter.

As an illustrative, non-limiting example, if a threshold value CiRT is zero and the controller 19 determines the value of the counter is zero, then the Take Action procedure proceeds to step S109, wherein the controller 19 resets flags, deactivates alarms, and updates the list of available proxies to indicate that the SIP proxy is available to the SIP session initiator 8 for establishing a media path Further, if the controller 19 in step S107 determines the value of the counter greater than zero, then the Take Action procedure is exited without resetting flags, deactivating alarms, and updating the list of available proxies. After the Take Action procedure is exited the test illustrated in FIG. 5 proceeds to step S111.

In an alternative embodiment of the present invention, a counter may be configured to have more than one threshold value that is compared to the value of a counter, thereby enabling different actions to be taken. For example, a comparison of the value of a counter with a first threshold may trigger the transmission of an alarm indicating a SIP proxy is not operating efficiently but has not been taken off the list, and a comparison of the value of a counter with a second threshold may trigger an alarm indicating a SIP proxy has been removed from the list of available proxies.

Step S111 of FIG. 5 represents the round-robin format of the non-limiting example of the tests performed by the SIP maintenance unit 9. In step S111, the controller 19 determines if all the SIP proxies SIP proxy 1, SIP proxy 2, and SIP proxy 3 have been tested, thereby completing the round-robin format of tests. In step S111, if there are SIP proxies in the system that have not been tested, the test proceeds to step S115, wherein the next SIP proxy is tested. Conversely, if the controller 19 in step S111 determines that the round-robin format of tests is completed, then the testing procedure proceeds to step S113, and the controller 19 instructs the SIP maintenance unit 9 to wait until the next prescheduled testing time (or event) before continuing the testing procedure. Step S115 represents the selection of the next SIP proxy to be tested. The next SIP proxy may be the next SIP proxy within a round-robin format of a test, or the first SIP proxy tested in a new round-robin format of test

In step S117, the controller 19 determines if an OOS2 flag was set during the previous test of the SIP proxy. If an OOS2 flag is set, this SIP proxy failed the previous Ping Test because of a network malfunction, and the SIP maintenance unit 9 should skip the SIP-proxy status test step and proceed with the Ping Test step to confirm the ability to contact the SIP proxy over the previously malfunctioning network. However, if an OOS2 flag is not set in step S117, the test proceeds to the SIP-proxy status test.

FIG. 7 is a detailed flowchart of the SIP-proxy status test step in FIG. 5. In FIG. 7, step S119 represents transmitting a test signal using communication unit 16 to the SIP proxy being tested. In step S121, the determining unit 18 determines whether or not a proper response is received from the SIP proxy in response to the test signal. If a proper response is received, the test is passed, and the testing procedure proceeds to step S123, wherein a counter is decremented. After the error counter is decremented in step S123, the testing procedure proceeds to the Take Action step, where the test in FIG. 5 originates. The testing procedure is then repeated.

However, if the determining unit 18 determines in step S121 that a proper response was not received from the SIP proxy in response to the test signal, the SIP-proxy status test proceeds to step S125. Step S125 indicates that the SIP-proxy status test in the exemplary embodiment illustrated in FIG. 7 is repetitive. In this exemplary embodiment of the SIP-proxy status test, the controller 19 is configured to instruct the communication unit 16 to retransmit the test signal to the same SIP proxy a predetermined number of times when a proper response is not received from the SIP proxy. For example, if the predetermined number of retries is 3 and the SIP proxy does not respond to the first test signal within two seconds of the transmitting an OPTION test message, then the controller 19 is configured to instruct the communication unit 16 to transmit a second OPTION test message having a four second timeout interval. Further, if again there is no response, a third and final OPTION test message is transmitted to the SIP proxy having an eight second timeout interval. If the SIP proxy does not reply to the third and final OPTION test message within the eight second timeout period, then the determining unit 18 is configured to determine the SIP-proxy status test is failed, and the SIP-proxy status test proceeds to step S127.

In step S127, the controller 19 is configured to determine if an OOS1 flag is set for the SIP proxy indicating the SIP proxy failed the previous SIP-proxy status test. If an OOS1 flag is set, the SIP-proxy status test proceeds directly to the Ping Test step explained in detail with respect to FIG. 8. Conversely, if an OOS1 flag is not set a counter is incremented in step S129, and the SIP-proxy status test proceeds to step S131. In step S131, the controller 19 is configured to compare the value of the counter with a threshold value C1FT assigned to the counter to determine if an OOS1 flag should be set. If the controller 19 determines the value of the counter is greater than the threshold value C1FT in step S131, the controller is configured to set an OOS1 flag and activate an alarm before the SIP-proxy status test ends, and the test illustrated in FIG. 5 proceeds to the Ping Test step. Conversely, if the controller determines the value of the counter is less than the threshold value C1FT, the SIP-proxy status test ends, and the test illustrated in FIG. 5 proceeds to the Ping Test step without setting an OOS1 flag or activating an alarm.

FIG. 8 is a detailed flowchart of the Ping Test step in FIG. 5. In step S135 of the exemplary embodiment of the Ping Test illustrated in FIG. 7, a ping signal is sent to the SIP proxy being tested. In step S137, the determining unit 18 is configured to determine if the ping signal times out, thereby indicating the SIP proxy cannot be reached by the SIP maintenance unit 9 due to a network malfunction. If the ping signal does not time out, a counter is decremented in step S139, and the testing procedure proceeds to the Take Action step. Conversely, if the ping signal does time out in step S137, the Ping Test proceeds to step S141, wherein the controller is configured to increment a counter. The Ping Test then proceeds to step S143. In step S143, if the determining unit 18 determines the value of the counter is greater than the assigned threshold value C2FT, the Ping Test proceeds to step S145 where an OOS2 flag is set and an alarm is activated before the Ping Test proceeds to the Take Action step. Conversely, if the controller determines the value of the counter is less than the threshold value C2FT, the Ping Test proceeds to the Take Action step without the setting an OOS2 flag or activation of an alarm.

In the exemplary embodiment of the present invention described above, the SIP maintenance unit 9 is configured to collect signaling information from the SIP session initiator 8, perform tests on the SIP proxies SIP proxy 1, SIP proxy 2 and SIP proxy 3, and manage the voice and multimedia sessions based on the tests of the SIP proxies. The tests performed by the SIP maintenance unit 9 and Take Action procedure conducted by the SIP maintenance unit 9 increase the reliability of call completion by enabling the SIP session initiator 8 to select an appropriate SIP proxy for communicating with an end user from a list of available proxies generated and modified by the SIP maintenance unit 9. Therefore, the present invention obtains as much SIP-proxy status information as possible by performing tests on the SIP proxies of a communication environment and enables the routing of session-related signaling around malfunctioning or overloaded remote SIP proxies. Further, the exemplary embodiment of the present invention described above enables reestablishing session-related signaling through previously malfunctioning SIP proxies when the malfunctioning SIP proxies begin responding normally to the test conducted by the SIP maintenance unit 9.

This invention may be implemented using a conventional general purpose computer or micro-processor programmed according to the teachings of the present invention, as will be apparent to those skilled in the computer art. Appropriate software can readily be prepared by programmers of ordinary skill based on the teachings of the present disclosure, as will be apparent to those skilled in the software art.

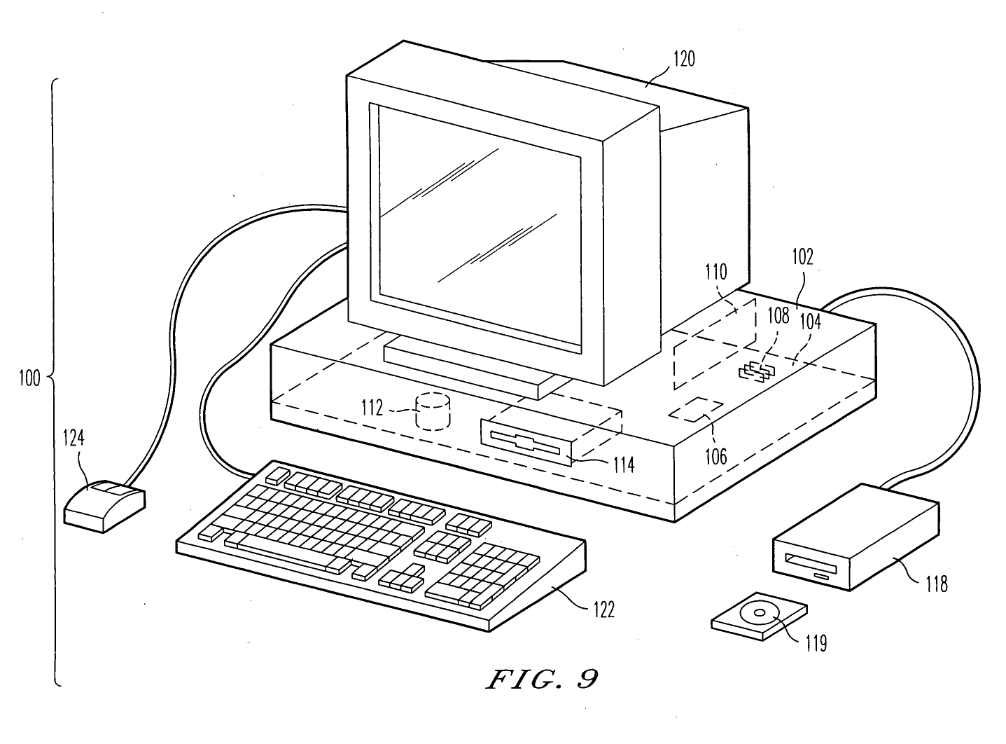

A non-limiting example of a computer 100 as shown in FIG. 9 may implement the method of the present invention, wherein the computer housing 102 houses a motherboard 104 which contains a CPU 106, memory 108 (e.g., DRAM, ROM, EPROM, EEPROM, SRAM, SDRAM, and Flash RAM), and other optical special purpose logic devices (e.g., ASICS) or configurable logic devices (e.g., GAL and reprogrammable FPGA). The computer 100 also includes plural input devices, (e.g., keyboard 122 and mouse 124), and a display card 110 for controlling a monitor 120. Additionally, the computer 100 may include a floppy disk drive 114; other removable media devices (e.g. compact disc 119, tape, and removable magneto-optical media (not shown)); and a hard disk 112 or other fixed high density media drives, connected using an appropriate device bus (e.g., a SCSI bus, an Enhanced IDE bus, or an Ultra DMA bus). The computer may also include a compact disc reader 118, a compact disc reader/writer unit (not shown), or a compact disc jukebox (not shown), which may be connected to the same device bus or to another device bus.

As stated above, the system includes at least one computer readable medium. Examples of computer readable media are compact discs 119, hard disks 112, floppy disks, tape, magneto-optical disks, PROMs (e.g., EPROM, EEPROM, Flash EPROM), DRAM, SRAM, SDRAM, etc. Stored on any one or on a combination of computer readable media, the present invention includes software for controlling both the hardware of the computer 100 and for enabling the computer to interact with a human user. Such software may include, but is not limited to, device drivers, operating systems and user applications, such as development tools. Such computer readable media further includes the computer program product of the present invention for performing the inventive method herein disclosed. The computer code devices of the present invention can be any interpreted or executable code mechanism, including but not limited to, scripts, interpreters, dynamic link libraries, Java classes, and complete executable programs. Moreover, parts of the processing of the present invention may be distributed for better performance, reliability, and/or cost.

The invention may also be implemented by the preparation of application specific integrated circuits or by interconnecting an appropriate network of conventional component circuits, as will be readily apparent to those skilled in the art.

Obviously, numerous modifications and variations of the present invention are possible in light of the above teachings. It is therefore to be understood that within the scope of the appended claims, the invention may be practiced otherwise than as specifically described herein.

1. A method for managing voice and multimedia sessions over a network, the method comprising:
initializing at least one SIP maintenance unit based on configuration data;
performing tests on a plurality of SIP proxies each controlling a media path and having a plurality of spans using the SIP maintenance unit;
adjusting a value of at least one error counter based on results of the performing tests; and
managing the voice and multimedia sessions based on results of the performing tests.

2. The method according to claim 1, wherein the initializing includes identifying attributes of the plurality of proxies and generating a list of available proxies.

3. The method according to claim 2, wherein the managing includes selecting an SIP proxy from the list of available proxies to be used for a multimedia session based on the results of the performing tests.

4. The method according to claim 3, wherein the performing tests includes performing a proxy status test, the proxy status test including:
connecting to at least one SIP proxy of the plurality of SIP proxies;
transmitting a test signal to the at least one SIP proxy; and
determining the proxy status test is at least one of passed and failed.

5. The method according to claim 4, wherein the transmitting is repeated until the determining determines the proxy status test is at least one of passed and failed.

6. The method according to claim 5, wherein the determining determines the proxy status test is passed when a proper reply is received from the at least one SIP proxy.

7. The method according to claim 6, wherein the determining step determines the proxy status test is failed when the transmitting step is repeated a predetermined number of times without receiving a proper reply from the at least one SIP proxy.

8. The method according to claim 7, wherein the performing tests further includes performing a ping test when the determining step determines the proxy status test is failed.

9. The method according to claim 4, wherein the adjusting includes incrementing a value of at least one counter by an increment value when the determining determines the proxy status test is failed.

10. The method according to claim 9, wherein the adjusting includes decrementing a value of the at least one counter by a decrement value when the determining determines the proxy status test is passed.

11. The method according to claim 10, wherein the increment value and decrement value are different.

12. The method according to claim 10, wherein the decrementing decrements a value of the at least one counter on predetermined time intervals.

13. The method according to claim 4, wherein the managing includes assigning a threshold value to each of the at least one counter and comparing a value of each of the at least one counter to the threshold value.

14. The method according to claim 13, wherein the managing further includes at least one of setting and resetting an alarm based on the comparing.

15. The method according to claim 14, wherein the comparing includes using hysteresis bands.

16. The method according to claim 3, wherein the managing further includes instructing the initializing, performing, and adjusting steps to repeat based on an addition of cat least one new SIP proxy.

17. The method according to claim 3, wherein the performing, adjusting, and managing are repeated at prescheduled time intervals.

18. The method according to claim 3, wherein the managing includes at least one of adding and removing at least one SIP proxy from the list of available proxies based on the results of performing tests.

19. The method according to claim 1, further comprising receiving signaling information from at least one SIP session initiator.

20. The method according to claim 19, wherein the signaling information includes results of in-line tests conducted during the use of at least one span of the plurality of spans.

21. The method according to claim 20, wherein the results of in-line tests include at least one of hardware outages, ring no answers, busy signals, and network malfunctions.

22. The method according to claim 21, wherein the managing is based on results of the performing tests and the received signaling information.

23. A system for managing voice and multimedia sessions over a network, the system comprising:
at least one SIP proxy configured to control at least one media path including a plurality of spans;
at least one SIP session initiator configured to select a SIP proxy from a list of available proxies and signal the selected SIP proxy to initiate a communication session using at least one of the plurality of spans;
a plurality of error counters; and
at least one SIP maintenance unit configured to communicate with the at least one SIP proxy, the at least one SIP session initiator, and the at least one error counter over a network and perform tests on the at least one SIP proxy.

24. The system according to claim 23, wherein the at least one SIP maintenance unit comprises a generating unit, a communication unit, a determining unit, and a controller.

25. The system according to claim 24, wherein the controller is configured to identify attributes of the least one SIP proxy and generate the list of available proxies based on configuration data.

26. The system according to claim 25, wherein the SIP maintenance unit is further configured to modify the list of available proxies based on results of the performed tests.

27. The system according to claim 26, wherein the generating unit is configured to generate at least one test signal.

28. The system according to claim 27, wherein the communication unit is configured to transmit the at least one test signal to the at least one SIP proxy and receive a response from the at least one SIP proxy.

29. The system according to claim 28, wherein the determining unit is configured to determine if the tests are at least one of passed and failed.

30. The system according to claim 29, wherein the controller is configured to instruct the communication unit to retransmit the at least one test signal to the at least one SIP proxy a predetermined number of times when a proper response is not received from the at least one SIP proxy.

31. The system according to claim 30, wherein the determining unit is configured to determine the test is passed when the communication circuit receives a proper response from the at least one SIP proxy.

32. The system according to claim 31, wherein the determining unit is configured to determine the test is failed when the communication circuit does not receive a proper response from the at least one SIP proxy.

33. The system according to claim 32, wherein the controller is further configured to update a value of at least one counter of the plurality of counters based on a result of each test provided by the determining unit.

34. The system according to claim 33, wherein the controller is further configured to increment at least one counter of the plurality of counters by an increment value when the test is passed.

35. The system according to claim 34, wherein the controller is further configured to decrement at least one counter of the plurality of counters by a decrement value when the test is failed.

36. The system according to claim 35, wherein the increment value and decrement value are different.

37. The system according to claim 36, wherein the controller is further configured to decrement that at least one counter of the plurality of counters at predetermined time intervals.

38. The system according to claim 37, wherein each of the plurality of error counters has a threshold value.

39. The system according to claim 38, wherein the controller is further configured to compare the threshold value of at least one counter to a value of the at least one counter.

40. The system according to claim 39, wherein the controller is further configured to set and reset alarms based on a comparison of the threshold value of the at least one counter to the value of the at least one counter.

41. The system according to claim 26, wherein the controller is further configured to add and remove at least one SIP proxy from the list of available proxies based on the results of performed tests.

42. The system according to claim 41, wherein the controller is further configured to identify available spans of each of the available proxies.

43. The system according to claim 23, wherein the plurality of error counters includes at least one error counter for each of the plurality of spans.

44. The system according to claim 26, wherein the at least one SIP session initiator is further configured to provide signaling information to the at least one SIP maintenance unit.

45. The system according to claim 44, wherein the signaling information relates to signals exchanged between the at least one SIP proxy and the at least one SIP session initiator before and during a media session.

46. The system according to claim 45, wherein the signaling information includes at least one of hardware outages, ring no answers, busy signals, and network malfunctions.

47. The system according to claim 46, wherein the SIP maintenance unit is further modify the list of available proxies based on results of the performed tests and the signaling information.

48. A system for managing voice and multimedia sessions over a network, the system comprising:
at least one SIP proxy configured to control at least one media path including a plurality of spans;
at least one SIP session initiator configured to select a proxy and signal the selected proxy to initiate a communication session using at least one of the plurality of spans;
a plurality of error counters;
means for identifying attributes of the at least one SIP proxy;
means for generating a list of available proxies;
means for testing the at least one SIP proxy;
means for adjusting a value of at least one error counter of the plurality of counters based on results of the means for testing; and
means for managing the voice and multimedia sessions based on the results of the means for testing.

49. A computer program product storing program instructions for execution on a computer system, which when executed by the computer system causes the computer system to perform a method for managing voice and multimedia sessions over a network, the method comprising:
initializing at least one SIP maintenance unit based on a configuration data;
performing tests on a plurality of SIP proxies each controlling a media path and having a plurality of spans using the SIP maintenance unit;
adjusting a value of at least one error counter based on results of the performing tests; and
managing the voice and multimedia sessions based on results of the performing tests.
